(19) United States
(12) Patent Application Publication
(10) Pub. No.: US 2010/0299166 A1
(43) Pub. Date: Nov. 25, 2010

(54) GENERATING RELEVANT KEYWORDS FOR MONETIZATION IN AN ELECTRONIC MAP ENVIRONMENT

(75) Inventors: ROMAN WAUPOTITSCH, REDMOND, WA (US); JEFF JUNYEN LIN, SEATTLE, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/468,614

(22) Filed: May 19, 2009

(51) Int. Cl. G06Q 30/00; G06F 17/30; G06Q 10/00

(52) U.S. Cl. 705/7; 707/E17.018; 707/E17.044; 707/E17.014; 705/14.58

(57) ABSTRACT

A method, system and computer readable medium directed towards generating relevant keywords for monetization from a user's experience in an electronic map environment. A user command to view a desired geographic area of an electronic map is received. The geographic area within the user's field of view is selected. Based on the geographic area, specific entities within the user's field of view are determined. A keyword phrase is generated based on information associated with the specific entities.

### BACKGROUND

Online advertising has become a significant aspect of the Web browsing experience. Today, many search engine providers receive revenue through advertisements positioned adjacent to a user's query results. In particular, when a user submits a search query to a search engine, the search engine will select advertisements and present the advertisements in conjunction with general search results for the user's query. Typically, search engine providers receive payment from advertisements based upon pay-per-performance models (e.g., cost-per-click or cost-per-action models). In such models, the advertisements returned with search results for a given search query include links to landing pages that contain the advertisers' content. A search engine provider receives payment from an advertisement to access the landing page and/or otherwise performs some action after accessing the landing page (e.g., purchase the advertiser's product).

Currently, all revenue in the search advertising market comes from keyword-based advertising. Sponsored links deemed relevant to a user's query are displayed alongside search engine results. These sponsored links or ads are sold via keyword auction where advertisers bid on keywords and phrases and pay the determined amount only when a user clicks on their advertisements. Search advertising's success is predicated on the specific identification of a user's intent at the time the user is interested in doing research or making a transaction.

In conjunction with search advertising, there are currently systems that implement location based advertising in conjunction with a user initiated query. For example, in an electronic map environment or a search engine, a user could type “Kansas City, Mo.” into the text box. Advertisements will be displayed solely based on the query typed into the text box using no other information such as a user's context or intent.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to generating relevant keywords for monetization in an electronic map environment. In particular, the relevant keywords are generated using specific entities located within a geographic area of a user's field of view. The keywords associated with the specific entities are given relevance values according to their relevance to the user's context and a keyword phrase is generated based on the keywords associated with the specific entities' relevance. The keywords generated from the electronic map environment may be used for monetization purposes. For instance, the keywords may be provided to an advertising system that returns advertisements that may be displayed in conjunction with the electronic map.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary architecture of the system in which embodiments of the invention may be employed;

FIG. 3 is a flow diagram showing a method for generating a keyword phrase in accordance with an embodiment of the present invention;

FIG. 4 is a flow diagram showing a method for generating a keyword phrase using categorical information about specific entities in accordance with an embodiment of the present invention;

FIG. 5 is a flow diagram showing a method for generating a keyword phrase using user behavior patterns in accordance with an embodiment of the present invention;

FIG. 6 is a flow diagram showing a method for determining when to utilize information collected from a collection of users in accordance with an embodiment of the present invention;

FIG. 7A illustrates an example of a user's field of view in an electronic map environment;

FIG. 7B illustrates another example of a zoomed in user's field of view in an electronic environment;

FIG. 8 illustrates an example of a three-dimensional view of a user's field of view in an electronic map environment;

FIG. 9 is a flow diagram that illustrates using keyword phrases to select relevant advertisements in accordance with an embodiment of the present invention; and

FIG. 10 is a flow diagram that illustrates an overall process of generating keyword phrases to generate relevant advertisements in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

As indicated previously, embodiments of the present invention generate keyword phrases from an electronic map environment for monetization purposes. An electronic map environment can be provided by a mapping web service that allows a user to view and manipulate a map on a computer screen. Keywords are retrieved from information pertaining to specific entities within a user's field of view. Keywords are used to generate a keyword phrase for monetization purposes. As used herein, “keyword phrase” may contain one or more words.

An electronic map environment, as described herein, is any representation of the real world (or a virtual world) that allows the user a way of viewing and navigating within this environment. This includes but is not limited to conceptual maps, and imagery (photographs, computer generated, etc.) that show an orthographic, oblique, 3D, or any other projection, of the world.

Each specific entity has information associated with it, such as categorical information and location information. An entity may be defined as any type of building or landmark located within a user's field of view. For example, restaurants, businesses, monuments, etc. could all be considered entities. A user's field of view is defined as the portion of the electronic map that the user is currently viewing. The user's field of view may contain different geographic areas or a single geographic area. A geographic area may be any type of geographic location such as a city, county, country, neighborhood, etc.

In some embodiments, categorical information is retrieved about each of the specific entities. The categorical information could be used to determine the relevance of the specific entity pertaining to a user's intent or could be used to generate more relevant keywords. By using a relevance value of entity-related keywords (e.g. travel, shopping, hotel, etc.) in conjunction with geographic content, relevant keyword phrases (e.g. “New York hotels,” “Las Vegas travel,” “Disneyland”) combine the two to generate and pass those phrases to a keyword-based advertising server, which can return the best advertisements matching those keywords. Further, the advertisement that would yield the highest revenue, as well as the most relevant advertisement could be returned.

In embodiments, a user's behavior patterns within a field of view are tracked to further determine the relevance of the specific entities. For example, if the user is panning rapidly, it might be an indication that the user has not found the desired entity. If on the other hand, the user is zooming closer to a particular entity, it is a strong indication that the user is interested in this particular entity. The user's behavior patterns are used in some embodiments to further weight the relevance of the specific entities, which helps to provide the most relevant keywords. Another indication is that the user might turn towards an object or entity within the field of view, thus, indicating further interest in the object or entity.

In some embodiments, information collected from a collection of users is used to provide further information about a specific user's intent. For example, in certain situations, it might be difficult to gather information about a specific user's intent based solely on the user's information provided, such as when the user is viewing a large geographic area. In that particular situation, information that has already been gathered from a collection of users can be used to provide statistical or more contextual information, which can help to provide relevant keywords.

Accordingly, in one aspect, an embodiment of the invention is directed towards a method for generating relevant keywords for monetization from a user's experience in an electronic map environment. The method includes receiving a user command to view a desired geographic area of an electronic map. The method also includes selecting the geographic area within a user's field of view. The method further includes determining specific entities within the user's field of view based on the geographic area. The method still further includes generating a keyword phrase based on information associated with the specific entities in the user's field of view.

Another embodiment of the present invention is directed towards a method for generating relevant keywords for monetization using categorical information from a user's experience in an electronic map environment. The method includes receiving a user command to view a desired geographic area of an electronic map. The method also includes selecting the geographic area within a user's field of view. The method further includes determining specific entities within the user's field of view based on the geographic area. The method further includes retrieving categorical information about each of the specific entities. The method further includes generating a relevance value for each of keywords associated with the specific entities based on the categorical information. The method further includes generating a keyword phrase based on the information associated with the specific entities in the user's field of view.

In another embodiment, the invention is directed towards one or more computer-storage media comprising computer-useable instructions that, when executed by a computing device, case the computing device to perform a method for generating relevant keywords for monetization from a user's experience in an electronic map environment. The method includes tracking user behavior within an electronic map environment wherein the user views different geographic areas within a user's field of view by panning or zooming. The method also includes determining specific entities within the user's field of view during the user's navigation of the different geographic areas. The method further includes retrieving at least one keyword associated with each specific entity. The method further includes generating a relevance value for each keyword associated with each of the specific entities based on the information pertaining to the user's field of view and the user's behavior. The method further includes generating a keyword phrase based on the at least one keyword associated with the specific entities and the relevance values for the at least one keyword. The method further includes selecting a relevant advertisement using the generated keyword phrase.

In yet a further aspect of the invention, an embodiment is directed to a system for generating relevant keywords for monetization by observing and analyzing a user's experience in an electronic map environment. The system includes a web service that provides an electronic map environment. The system also includes a user specific behavioral store that stores behavior patterns pertaining to a specific user, which communicates statistical user specific information to a keyword phrase generator. The system further includes a general user behavioral store that stores behavior patterns observed from a collection of users, which communicates general statistical behavioral information to the keyword phrase generator. The system further includes the keyword phrase generator which retrieves information pertaining to a user's field of view and user's behavior patterns observed within the web service and generates keyword phrases based derived from the electronic map environment including specific entities within the user's field of view, wherein the keyword phrase generator further receives information from the user specific behavioral store and information from the general user behavioral store for use in generating the keyword phrases. The system further includes a keyword based advertising server which receives keyword phrases from the keyword phrase generator, which returns advertising information based on the keyword phrases.

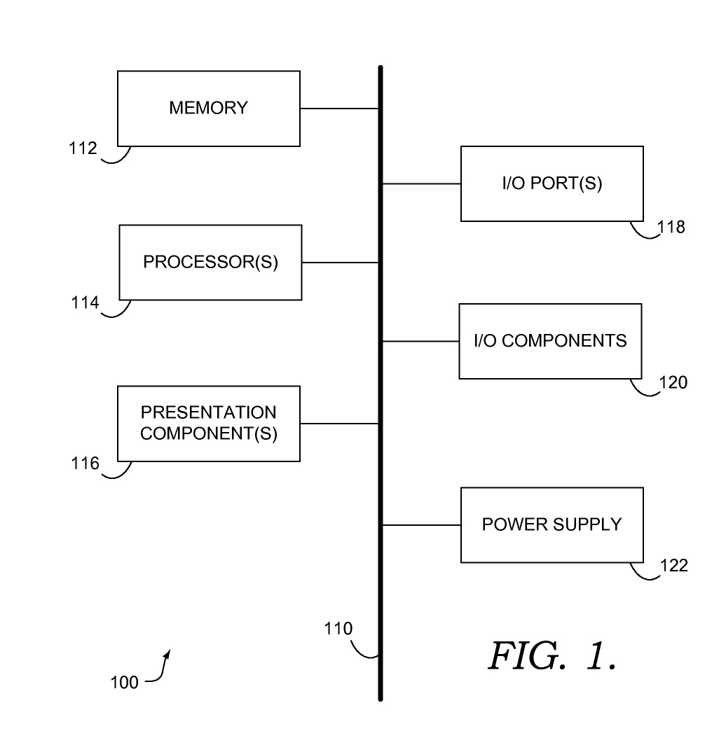

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

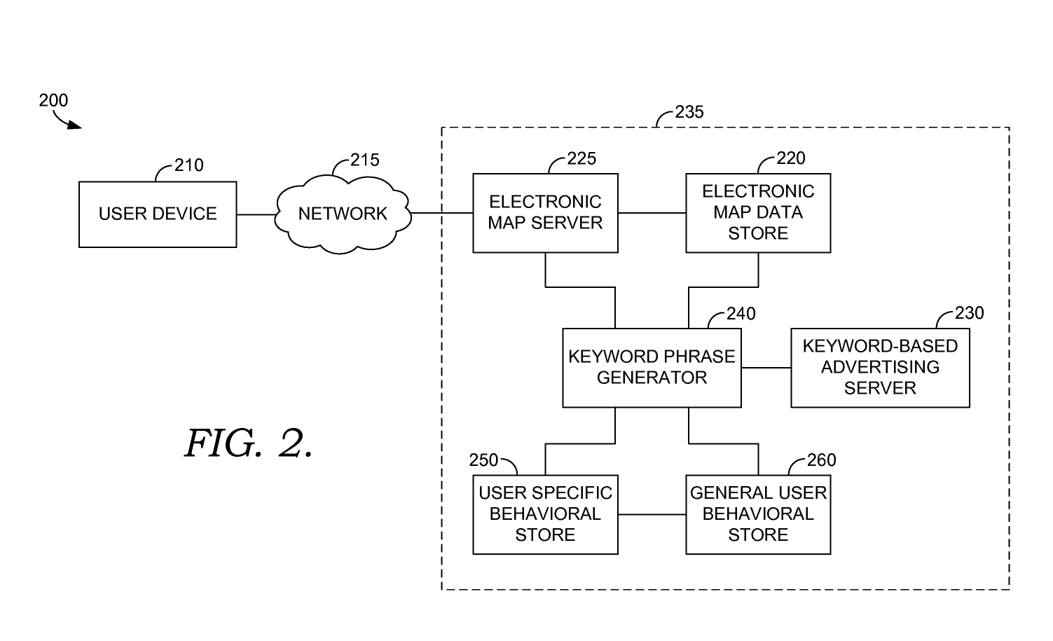

Turning to FIG. 2, a block diagram is illustrated which shows a system 200 for generating relevant keywords by observing and analyzing a user's experience in an electronic map environment. Among other components not shown, the system 200 may include a user device 210 and an electronic web service 235 including an electronic map data store 220, an electronic map server 225, a user specific behavioral store 250, a general user behavioral store 260, a keyword phrase generator 240, and a keyword-based advertising server 230. Each of the components shown in FIG. 2 may be any type of computing device, such as computing device 100 described with reference to FIG. 1, for example. The user device 210 may communicate with the electronic map service 235 via a network 215, which may include, without limitation, one or more local area networks (LANs) and/or wide area networks (WANs). Such networking environments are commonplace in offices, enterprise-wide computer networks, intranets, and the Internet. It should be understood that any number of storage devices, advertisement servers, advertiser servers, user devices, and networks may be employed within the system 200 within the scope of the present invention. Additionally, other components not shown may also be included within the system 200.

The system 200 generally illustrates the user device 210 accessing an electronic map service 235 providing an electronic map environment. The electronic map server 225 receives a command to view a geographic area from the user device 210 via the network 215. The electronic map server 225 retrieves information associated with the requested geographic area from the electronic map data store 220. The electronic map server 225 requests information from the electronic map data store 220 to display the desired geographic information to the user device 210 within the displayed user's field of view within the electronic map environment.

The electronic map data store 220 stores information pertaining to electronic map data such as location information and map data. The electronic map data store 220 also stores information regarding specific entities. Generally, the electronic map data store 220 may store information regarding any entity with which a user may wish to have identified within the electronic map environment. By way of example only and not limitation, the entities for which information may be stored in the electronic map data store 220 may include restaurants, hotels, stores, theaters, stadiums, and amusement parks, to name a few. Information that may be included for an entity within the electronic map data store 220 may include an identification of the entity, a location of the entity, and categorical information for the entity. It should be noted that the specific entities and associated information in embodiments are not paid advertisements but are information collected by the electronic map provider to provide a more robust user experience within the electronic map environment by being able to identify these entities within the electronic map.

Once the desired geographic area is displayed within the user's field of view on the user device 210, specific entities within the user's field of view are determined. The electronic map data store 220 provides information associated with the specific entities to the keyword phrase generator 240, which analyzes the information to identify keywords associated with each specific entity. For example, an Italian restaurant “Bella Italia” could possibly be associated with at least four keywords, such as “Italian,” “restaurant,” “Bella,” and “Italia.” It should be appreciated that many more keywords could be associated with each entity including information pertaining to the geographic area of the specific entity. Also, the electronic map data store 220 may contain categorical information pertaining to the specific entities. The keyword phrases generator 240 or another component retrieves categorical information to generate more keywords associated with the specific entities within the user's field of view.

In one embodiment, when the keywords are identified by the keyword phrase generator 240, the keywords are used to generate a keyword phrase. A keyword phrase may contain one or more words based on the keywords. The keyword phrase is sent to the keyword-based advertising server 230. The keyword-based advertising server 230 uses the keyword phrase to select one or more advertisements. The advertisements can be selected many different ways such as highest paying advertisement, the top five advertisements matching the keyword phrase, etc.

In another embodiment, when the keywords are identified by the keyword phrase generator 240, the keywords are given a relevance value. The relevance value can be determined by many different factors. For example, the relevance value can be determined by the location of the specific entity associated with the keyword within the user's field of view. If the specific entity is close to the center of the user's field of view, the relevance value could be higher. Relevance may also be determined based on the number of entities associated with a given keyword. For example, three out of five of the specific entities within the user's field of view contain the keyword “restaurant.” This might imply that the user is searching for a restaurant, and the keyword “restaurant” is given a higher relevance value.

In another embodiment, the user might navigate between several different geographic areas and this creates user behavior patterns. User behavior patterns might include panning and zooming, for example. The user specific behavioral store 250 stores behavior patterns or any other information pertaining to a specific user and communicates statistical user specific behavioral information to the keyword phrase generator 240. The general user behavioral store 260 stores behavior patterns or other information observed from a collection of users and communicates general statistical behavioral information to the keyword phrase generator 240. The keyword phrase generator 240 retrieves information pertaining to a user's field of view and information relevant to the user. The keyword phrase generator 240 further receives information from the user specific behavioral store 250 pertaining to the user's context and information from the general user behavioral store 260 is used to supplement the relevant information when needed. The keyword-based advertising server 230 receives keyword phrases from the keyword phrase generator 240, and then returns advertising information based on the keyword phrases. In one embodiment, the keyword-based advertising server determines the advertisement that will return the highest revenue for the keyword received.

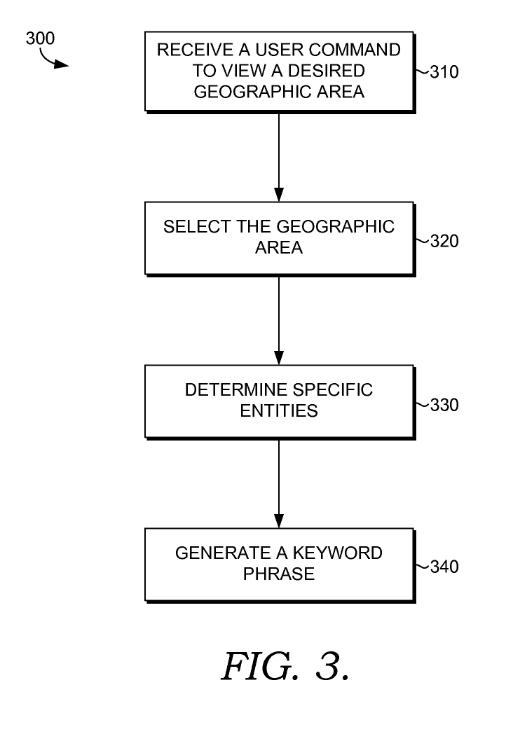

Referring now to FIG. 3, a flow diagram is provided illustrating an exemplary method 300 for generating relevant keywords for monetization in an electronic map environment in accordance with an embodiment of the present invention. Initially, as indicated at block 310, a user command is received to view a desired geographic area and thus, a geographic area is selected, at block 320. The user views the desired geographic area within the user's field of view. Geographic areas can be any area that describes geographic locations such as a neighborhood, city, postcode, country, etc. For instance, a user may choose to view a subset of a metropolitan area within the field of view. The geographic area could still be described as the metropolitan area or a more specific neighborhood. The user's field of view is the portion of the geographic area actually viewed by the user.

Next, specific entities within the field of view are determined, as shown at block 330. Specific entities can be any number of objects within the user's field of view, such as businesses, landmarks, buildings, parks, etc. Next, a keyword phrase is generated based on keywords associated with the specific entities, as shown at block 340. The keyword phrase can be generated by an algorithm that combines any number of algorithms including but not limited to a predetermined mapping between categories (or sequence of categories) and associated keywords. For example “hotel,” “resort,” “bed and breakfast” could be mapped to keywords “travel” and “vacation.” Another example of the type of algorithm that might be used is a known or estimated value and inventory levels of keywords provided by an advertising server, for example, if the advertising server has a specific consumer in mind. Also, metadata, such as tags, titles, etc. of any extra or supplemental content within the mapping environment, might be used. Supplemental content is content that the user has engaged in with the context of the map environment, such as photos, reviews, or user comments.

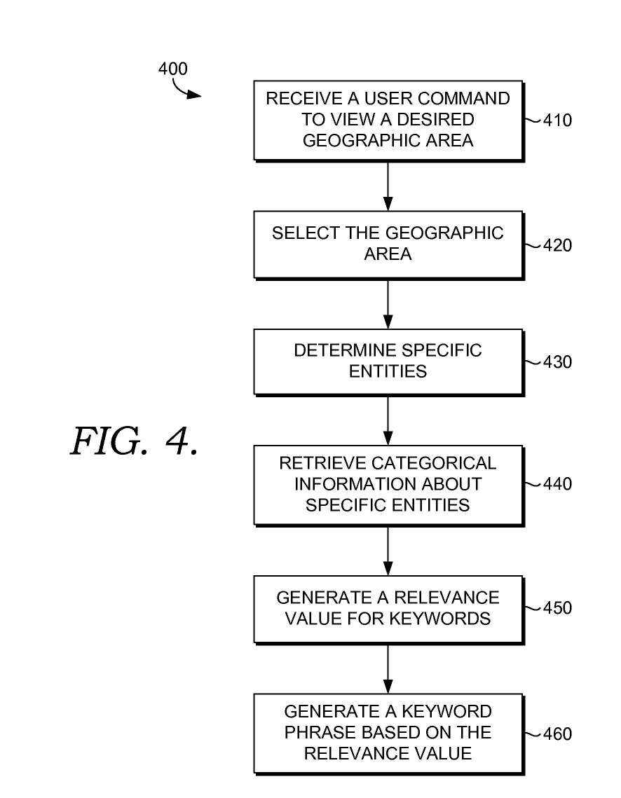

Referring now to FIG. 4, a flow diagram is provided to illustrate an exemplary method 400 for generating relevant keywords using categorical information and relevance information for monetization in an electronic map environment in accordance with an embodiment of the present invention. The method 400 starts similarly to method 300 in FIG. 3 with receiving a user command to view a desired geographic area, as shown at block 410. Next, a geographic area is selected, as shown at block 420 and then, specific entities of the geographic area within the user's field of view are determined, as shown at block 430. Next, categorical information about the specific entities is retrieved, as shown at block 440. Categorical information about the specific entities allows the keywords to be more relevant to the user's context. For example, if a user is looking at an Italian restaurant, category information such as “Italian restaurant” and “restaurant” would be associated with the specific entity. A relevance value is generated for each of the keywords associated with each of the specific entities, as shown at block 450, using the categorical information and other context information. Other information such as the distance from the center of an aerial view map or closest proximity in a street view map could be taken into consideration when generating the relevance value for the keywords associated with each of the specific entities. Additionally, the relevance for a given keyword may be based on the number of entities associated with the keyword. The keyword phrase is generated based on the relevance values of the keywords associated with each of the specific entities to provide the user with the most relevant advertisement according the user's context, as shown at block 460.

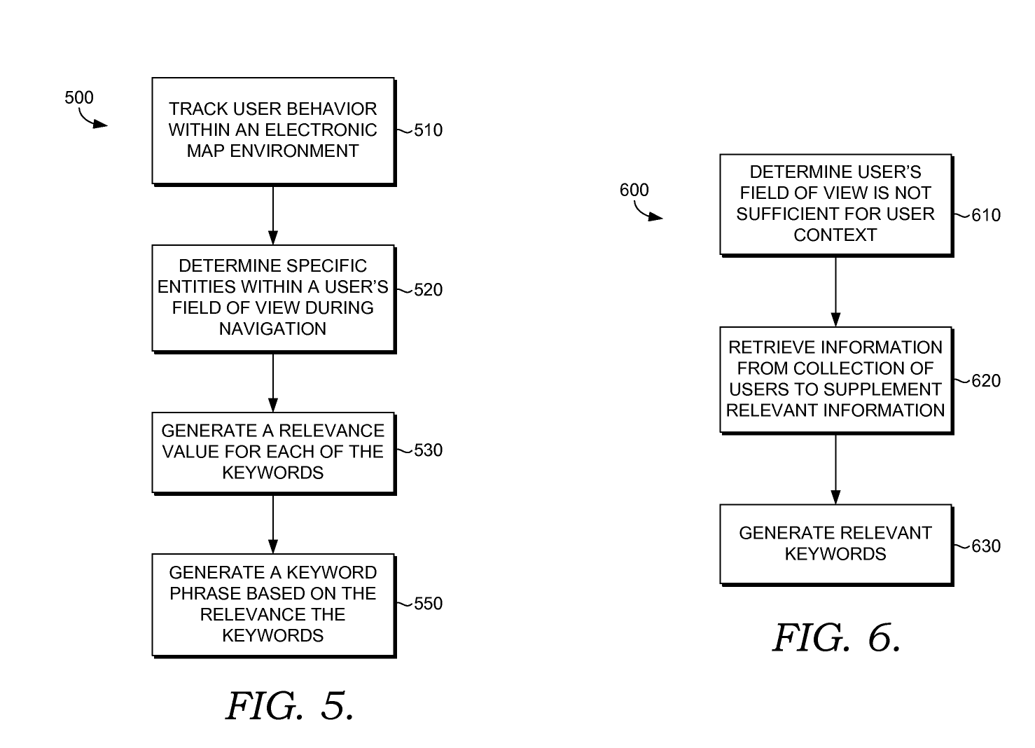

Referring now to FIG. 5, a flow diagram is provided to illustrate an exemplary method 500 for generating relevant keywords by tracking user behavior for monetization in an electronic map environment in accordance with an embodiment of the present invention. User behavior is tracked within an electronic map environment, as shown at block 510. Information can be logged in sequence, giving snapshots of the user's activity within the field of view over time. This can be useful to extrapolate the user's intent that may not be apparent in a single “snapshot,” and thus more accurately determine intent, and better relevance. This could be done either with statistical methods that analyzed observed past user behavior patterns to determine, for example, that users that generate successive snapshots of entities that are classified as hotels and amusements parks in cities that are top tourist destinations, are with a high probability very likely on vacation. Whereas, if the same user generates snapshots of entities that are classified as hotels and office buildings, the user has a high probability of interest in business Such determination could be done using a variety of well-known statistical methods monitoring previous user behavior. The exact features that are monitored are generic and could apply to other virtual world environments (e.g. Second Life, World of Warcraft) as representations of the real world; not entities but geographies (cities, states) can be used to glean this information. As the user continues to generated “snapshots,” they can be further classified with more accuracy.

Tracking user behavior is also useful both when meaningful information can not yet be determined from the user's current context or when there is simply no information about a user (such as at the beginning of a session). For example, a user might view an entire state within the field of view midway during a session. Rather that throwing away all of the past navigation information can be used to draw conclusions about the user's intent.

In the same case, at the beginning of a session where there is no additional information about the user, and there is an entire state in within the field of view, it could have been observed for instance, that a majority of users who view this state (Nevada, for instance) ultimately wind up with a vacation context; the ability to guess early with more than random probability of being right returns an advantage. Without any other information, it would be difficult to determine the user's specific intent with any accuracy. Understanding the user's intent can be reflected in any keywords that are generated.

Next, information regarding specific entities within the field of view is tracked while the user navigates the electronic map, as shown at block 520. This information may include identification of entities, where entities appeared within the map, panning speed over entities, zoom information, etc. For example, the amount of time an entity is within the user's field of view may be taken into consideration when determining relevance. If the entity is panned over quickly, the entity would not be considered highly relevant; whereas when the entity remains within the user's field of view for a significant amount of time, the entity is given a higher relevance.

Then, a relevance value is generated for each of the keywords associated with the specific entities, at least in part based on the information collected from the user's navigation over time, as shown at block 530. For example, if a user pans quickly over a specific entity, it should be given lower relevance value than if a user zooms in on a specific entity. Using the relevance value of each of the keywords associated with the specific entities, many different algorithms may be used to determine the most relevant keywords. A keyword phrase is generated based on the relevance value of each of the keywords associated with the specific entities, as shown at block 550.

Referring to FIG. 6, a flow diagram is provided to illustrate an exemplary method 600 for using information from a collection of users for monetization in an electronic map environment in accordance with an embodiment of the present invention. Initially, it is determined if the user's field of view is sufficient to determine relevant user context, as shown at block 610. For example, a user could be viewing an entire state within the field of view. The user's context or intent would be difficult to determine at that point. Information collected from a collection of users might give more relevant information. The information could be based on statistics or observed from other users in a similar mapping environment. Next, the information from a collection of users is retrieved to supplement any relevant information, as shown at block 620. Examples of the type of information could be specific entities, categorical information or behavior patterns. Next, using any relevant information already collected pertaining to the user's context and any information supplemented from the collection of users, keywords or a keyword phrase are generated, as shown at block 630.

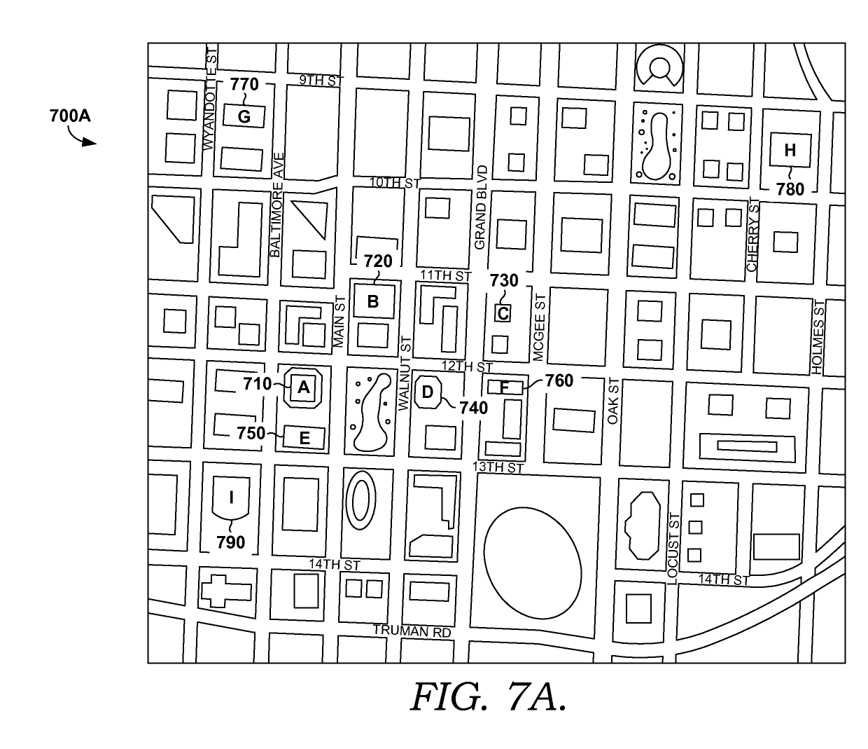

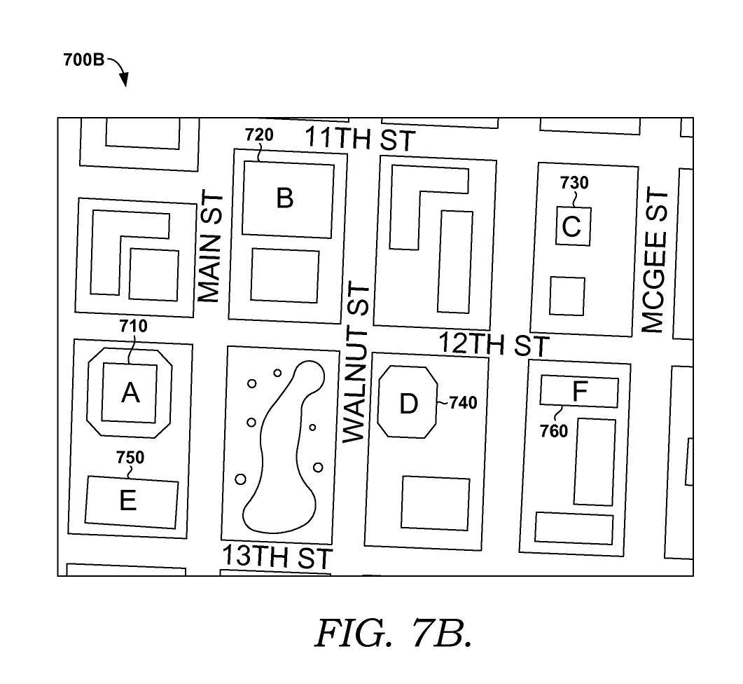

Now referring to FIG. 7A, a screen shot is provided that illustrates an example of a user's field of view 700A in an electronic map environment in accordance with an embodiment of the present invention. Within the user's field of view 700A, several specific entities are displayed and labeled with reference numbers and letters, including entity A 710, entity B 720, entity C 730, entity D 740, entity E 750, entity F 760, entity G 770, entity H 780, and entity I 790. FIG. 7A illustrates specific entities being identified and determined within the user's field of view. As discussed above, relevance for keywords may be based at least in part on the location of entities corresponding with the keywords within the user's field of view. For instance, keywords associated with entities closer to the center of the user's field of view 700A may be determined to have higher relevance as compared to keywords associated with entities further from the center of the user's field of view 700. For example, it might be determined that keywords given the most relevance would be those associated with a specific entity that is the closest to the center of the user's field of view 700A. The specific entity in this example that is closest to the center of the user's field of view 700A is entity F 760. In this example, the keywords associated with entity F 760 would be given a higher relevance value than the other keywords associated with the other specific entities within the user's field of view 700A.

Now referring to FIG. 7B, a screen shot is provided that illustrates another example of a zoomed in user's field of view 700B in an electronic environment in accordance with an embodiment of the present invention. In one embodiment, FIG. 7A and FIG. 7B could be combined to track a user's behavior patterns. FIG. 7A is a zoomed out view of the map environment of FIG. 7B. FIG. 7A illustrates a wider view of the same geographic area illustrated in FIG. 7B. It might be determined that a user zoomed in on these particular specific entities and therefore, theses specific entities within the user's field of view of FIG. 7B (e.g. from FIG. 7A to FIG. 7B) and the keywords associated therewith have a higher relevance value than the specific entities not shown within the user's field of view. In FIG. 7B, the entity that is the closest to the center is “D” 740, and in one embodiment, this entity could be given a higher relevance value.

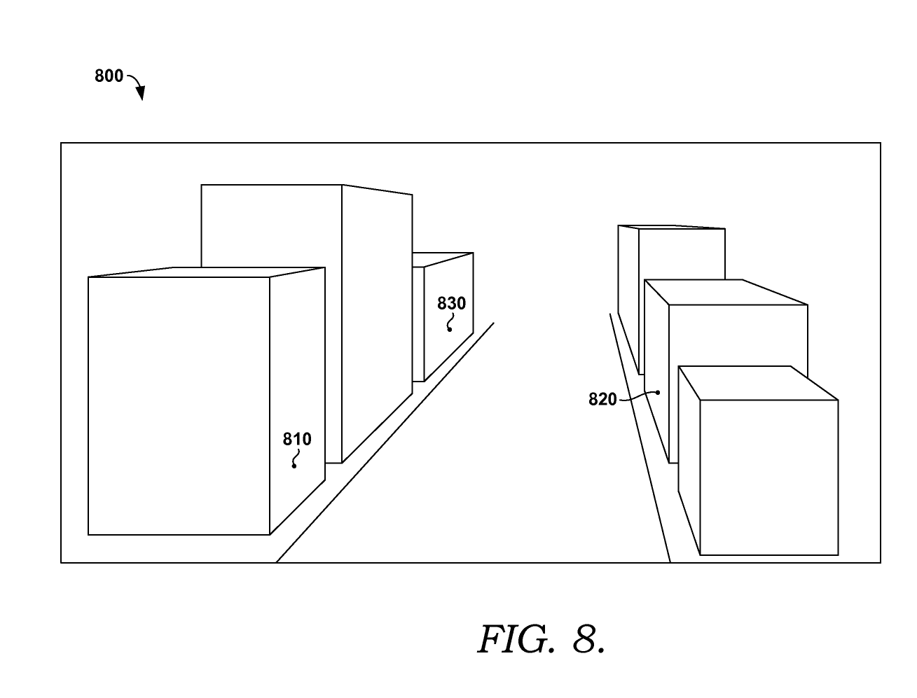

Now referring to FIG. 8, a screen shot is provided that illustrates an example of a three-dimensional view of a user's field of view 800 in an electronic map environment in accordance with an embodiment of the present invention. The present invention is not limited to two-dimensional views and it should be appreciated that the present invention takes into consideration three-dimensional map environments. The reference numbers 810, 820, and 830 illustrate different specific entities within the user's field of view 800. Instead of determining which entity that is closest to the center of the electronic map, another embodiment of the present invention determines the entity that is the closest in proximity to the user from the user's viewpoint in the virtual three-dimensional environment. For example, while the entity represented by 830 is closest to the center of the electronic map, the entity represented by 810 is actually closer to the user's point of view.

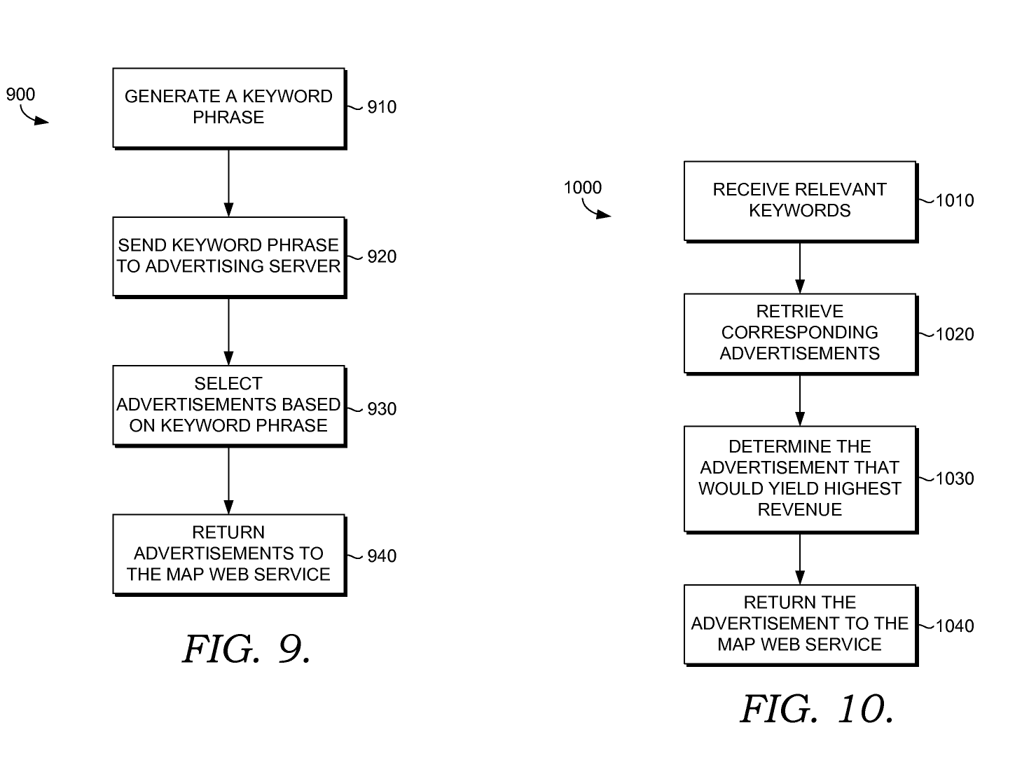

Now referring to FIG. 9, a flow diagram is provided to illustrate an exemplary method 900 for using keyword phrases to select relevant advertisements in accordance with an embodiment of the present invention. A keyword phrase is generated, as shown at block 910, for instance, by using a method such as those described with reference to FIGS. 3-6. The keyword phrase is sent to the keyword-based advertising server, as shown at block 920. The keyword-based advertising server selects advertisements based on the keyword phrase, as shown at block 930. Several different advertisements could be associated with the keyword phrase. The keyword-based advertising server might use many different selection methods when selecting the most relevant advertisement. For example, the advertisement might be selected further based on the advertisement or advertisements that yield the highest revenue or the advertisement might be selected based on just the top five advertisements associated with the keyword phrase. It should be appreciated that many different selection methods might be used to select the advertisement to be returned to the map web service. Then the advertisement that is selected is returned to the map web service, as shown at block 1040, and then provided to the user for display.

Now referring to FIG. 10, a flow diagram is provided to illustrate an exemplary method 1000 for retrieving relevant advertisements in an electronic map environment in accordance with an embodiment of the present invention. The relevant keywords or keyword phrase is received by a keyword-based advertising server from a keyword phrase generator, as shown at block 1010. The keyword-based advertising server retrieves corresponding advertisements by performing a search query using the received keywords or keyword phrase, as shown at block 1020. Next, it is determined which advertisement would yield the highest revenue, as shown at block 1030. It is appreciated that the determination of the advertisement yielding the highest revenue can be determined in any number of ways. One example could be the advertiser that has the highest bid. The highest yielding advertisement is returned to the map web service to be displayed to the user, as shown at block 1040.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method for generating relevant keywords for monetization from a user's experience in an electronic map environment, the method comprising:
receiving a user command to view a desired geographic area of an electronic map;
selecting the geographic area within a user's field of view;
determining specific entities within the user's field of view based on the geographic area;
generating a keyword phrase based on information associated with the specific entities in the user's field of view

2. The method of claim 1, wherein determining of the specific entities within the user's field of view further comprises retrieving categorical information about the specific entities.

3. The method of claim 2, wherein generating the keyword phrase is based at least in part on the categorical information about the specific entities.

4. The method of claim 2, wherein the method further comprises generating a relevance value for each of the keywords associated with the specific entities within the user's field of view.

5. The method of claim 4, wherein the relevance value for each keyword is used to generate the keyword phrase.

6. The method of claim 4, wherein the relevance value for each keyword associated with each of the specific entities is based on a location of each specific entity within the user's field of view.

7. The method of claim 4, wherein the relevance value is based on the number of specific entities corresponding with the keyword.

8. The method of claim 1, wherein the method further comprises selecting an advertisement using the keyword phrase.

9. The method of claim 1, further comprising accessing information from a collection of users.

10. The method of claim 9, wherein the keyword phrase is generated based at least in part on the information from the collection of users.

11. One or more computer-storage media comprising computer-useable instructions that, when executed by a computing device, cause the computing device to perform a method for generating relevant keywords for monetization from a user's experience in an electronic map environment, the method comprising:
tracking user behavior within an electronic map environment wherein the user views different geographic areas within a user's field of view by panning or zooming;
determining specific entities within the user's field of view during navigation of the different geographic areas;
retrieving at least one keyword associated with each specific entity;
generating a relevance value for each keyword associated with each of the specific entities based on information pertaining to the user's field of view and the user's behavior;
generating a keyword phrase based on the at least one keyword associated with the specific entities and the relevance values for the at least one keyword; and
selecting a relevant advertisement using the generated keyword phrase.

12. The one or more computer-storage media of claim 11, wherein determining specific entities within the user's field of view further comprises retrieving categorical information about the specific entities.

13. The one or more computer-storage media of claim 12, wherein generating the keyword phrase further includes the categorical information about the specific entities.

14. The one or more computer-storage media of claim 11, wherein the relevance value of a keyword is based on at least the amount of time a specific entity is within the user's field of view.

15. The one or more computer-storage media of claim 11, wherein the relevance value for each of the specific entities is based on the location of each specific entity within the user's field of view.

16. The one or more computer-storage media of claim 11, wherein generating the keyword phrase is further based on information from a collection of users.

17. A system for generating relevant keywords for monetization by observing and analyzing a user's experience in an electronic map environment, the system comprising:
a web service that provides an electronic map environment;
a user specific behavioral store that stores behavior patterns pertaining to a specific user, which communicates statistical user specific behavioral information to a keyword phrase generator;
a general user behavioral store that stores behavior patterns observed from a collection of users, which communicates general statistical behavioral information to the keyword phrase generator;
the keyword phrase generator which retrieves information pertaining to a user's field of view and user's behavior patterns observed within the web service and generates keyword phrases based on information derived from the electronic map environment including specific entities within the user's field of view, wherein the keyword phrase generator further receives information from the user specific behavioral store and information from the general user behavioral store for use in generating the keyword phrases; and
a keyword based advertising server which receives keyword phrases from the keyword phrase generator and returns advertising information based on the keyword phrases.

18. The system of claim 17, wherein the keyword based advertising server determines the advertisement that will return the highest revenue for the received keyword.

19. The system of claim 17, wherein the observed user behavior patterns includes panning and zooming.

20. The system of claim 17, wherein the system further includes an electronic map data store which stores information associated with an electronic map and an electronic map server that communicates information from the electronic map data store and displays the information to a user over a network.
